(19) United States
(12) Patent Application Publication
(10) Pub. No.: US 2010/0121699 A1
(43) Pub. Date: May 13, 2010

(54) METHOD AND SYSTEM FOR WEB-BASED INCENTIVE ACQUISITION MARKET MAKING

(76) Inventor: PHYLLIS PIERCE, New Canaan, CT (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/615,595

(22) Filed: Nov. 10, 2009

Related U.S. Application Data
(60) Provisional application No. 61/113,865, filed on Nov. 12, 2008.

(51) Int. Cl. G06Q 30/00; G06Q 50/00; G06Q 20/00; G06F 15/16

(52) U.S. Cl. 705/14.16; 705/26; 705/80; 709/217

(57) ABSTRACT

A method and system for web-based incentive acquisition of material and non-material items is proposed involving an originator designating a desired acquisition interacting with a central host controller or manager system. An electronic system allows an originator to define a commodity or service and set an initial bounty, transferable to a system-member-participant who assists such acquisition upon proof of such assistance. Variations of the present system enable adaptation to employment, personal property, and service circumstances. An alternative module enables a financial rating and a reliability rating for both system members and participants. A financial module allows for holding of deposit funds or value offered for consideration of action in enabling the formation of a binding contract.

### REFERENCE TO RELATED APPLICATIONS

This application relates to U.S. Provisional Application Ser. No. 60/991,086 filed Nov. 29, 2007 and relates to, and claims priority from, U.S. Provisional Application Ser. No. 61/113,865, filed Nov. 12, 2008, the entire contents of each of which is fully incorporated herein by reference.

### BACKGROUND OF THE INVENTION

1. Field of the Invention

The present invention relates to a web-based or electronic linked-node system supporting an incentive focused acquisition system. More specifically, the present invention relates to an interconnected computerized device system enabling an incentive bounty for acquisition of material and non-material items.

2. Description of the Related Art

The related art involves the use of bonus or reward-based incentive programs to employees for every new hire they refer to an employer. An example of this is seen in the business practices of Nortel Networks and CareerBuilder.com.

In a related, but different business operation, BountyJobs (a property of BountyJobs Inc.) operates as a web marketplace where employers offer bounties to recruiters for delivering successful employee placements. At the BountyJobs site, employers post bounties, headhunters deliver talent, employees reward headhunters, and headhunters give up to twenty-five percent (25%) of their fee to BountyJobs.

It is also known for web-based services, such as www.craigslist.com, to provide a hosted site for people to place public ads of their own for various services and products. On Monster.com, employers pay for all ads that they post.

Unfortunately, what is not appreciated by the prior art is the personal desire for an originator wishing to acquire employment, a product, or other non-material item to be able to offer a self-promoting bounty or incentive to others to assist the originator in achieving their desire.

Accordingly, there is a need for an improved method and system for web-based incentive acquisition of material and non-material items such as employment, a desired property, or other item.

What is also not appreciated is the desire for such an originator making such an offer to avoid the risk of fraud and loss of the offer without reaping the benefit of the acquisition.

### OBJECTS AND SUMMARY OF THE INVENTION

An aspect of the present invention is to provide a method and system for web-based incentive acquisition of material and non-material items or commodities of varied types.

Another aspect of the present invention is to provide such a method and service in an electronically accessible format enabling secure access by members, to users, participants, and facilitator individuals.

The present invention relates to a method and system for web-based incentive acquisition of material and non-material items is proposed involving an originator designating a desired acquisition interacting with a central host controller or manager system. An electronic system allows an originator to define a seeking desire and set an initial value or bounty transferable to a system-member-participant who assists such acquisition upon proof of such assistance. Variations of the present system enable adaptation to employment, personal property, real estate, and other commodity and service circumstances. Alternative modules enable a financial rating and a reliability rating for both system members and participants. A financial module allows for holding of deposit funds or value offered for consideration of action to enabling the formation of a binding contract.

In another embodiment, the present invention is a method and system of making a market within a host data processing system wherein a bounty is paid by a user posting a commodity description on the system for view by potential commodity agents, who, in turn, will attempt to match the posted commodity with a third party desirous of acquiring the same.

The invention's method comprises a number of steps; these begin with the establishment of a data base comprising data relative to a commodity that is available. A commodity can be anything from an individual seeking a job, to a household item such as a used bookcase, to an available service such as tax preparation or the like. In a subsequent step a bounty is determined and posted together with the commodity description. The bounty will be paid by the commodity agent to a transaction agent for a successful acquisition of the commodity by a third party. It is important to note, that the transaction agent and the third party can be the same party. This is achieved when an entity requiring a particular commodity or service becomes a system user through membership or other participation, and takes on the role of transaction agent for their own benefit. Once posted, the commodity description and related bounty are available for review by a potential transaction agent via remote node through an interne connection in cooperation with the data processing system.

Once the data base is established, a matching routine can be run for matching the posted description with one or more needs descriptions posted by a potential transaction agent of the commodity; or, the potential transactions agent can simply scroll through the entire list of stored commodities, or a defined subset thereof. The matching routine can be run at pre-determined intervals, performed continuously, or can be performed on an as-needed basis. If a match is determined between the one or more needs descriptions and the described commodity, then the system generates a contract based upon the account data of both the user (commodity agent) and the potential transaction agent and in respect of the match. If no match is determined between the one or more needs descriptions and the described commodity, then the posted description can be maintained in the data base for use in a future running of the matching routine. The bounty becomes payable by the commodity agent to the transaction agent, in respect of the contract, to complete a transaction. The system, through the use of a forms library, or though the creation of a customized form, can generate a report in respect of the transaction.

The system of the invention comprises a host data processing system together with a set of routines and functionality that facilitate posting of commodity descriptions and corresponding search criteria.

The system further comprises a data base. The data base, in turn, comprises data posted by the commodity agent relative to the commodity that is available. The data further comprises a description of the bounty to be paid to the transaction agent for a successful acquisition of the commodity by a third party. Additionally, the posted description of the commodity, together with a listing of the bounty, is available for review by system members (potential transaction agents) by a remote node through an internet connection in cooperation with the data processing system.

The system further comprises payment acceptance means for allowing a user of the system to make a payment in respect of a use of the system. The payment acceptance means is capable of taking the payment from the user of the system for the bounty on an escrow basis; the escrowed payment to be released to the transaction agent upon a completed transaction.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a high level pictorial schematic depicting the system of the present invention.

FIG. 2 is a block diagram of the host central processing unit showing each of its constituent routines.

FIG. 3 is an upper level flowchart of the method of the present invention.

FIG. 4 is a flowchart of the method for the job maker routine of the present invention.

FIG. 5 is a flowchart of the method for the product sale maker routine of the present invention.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

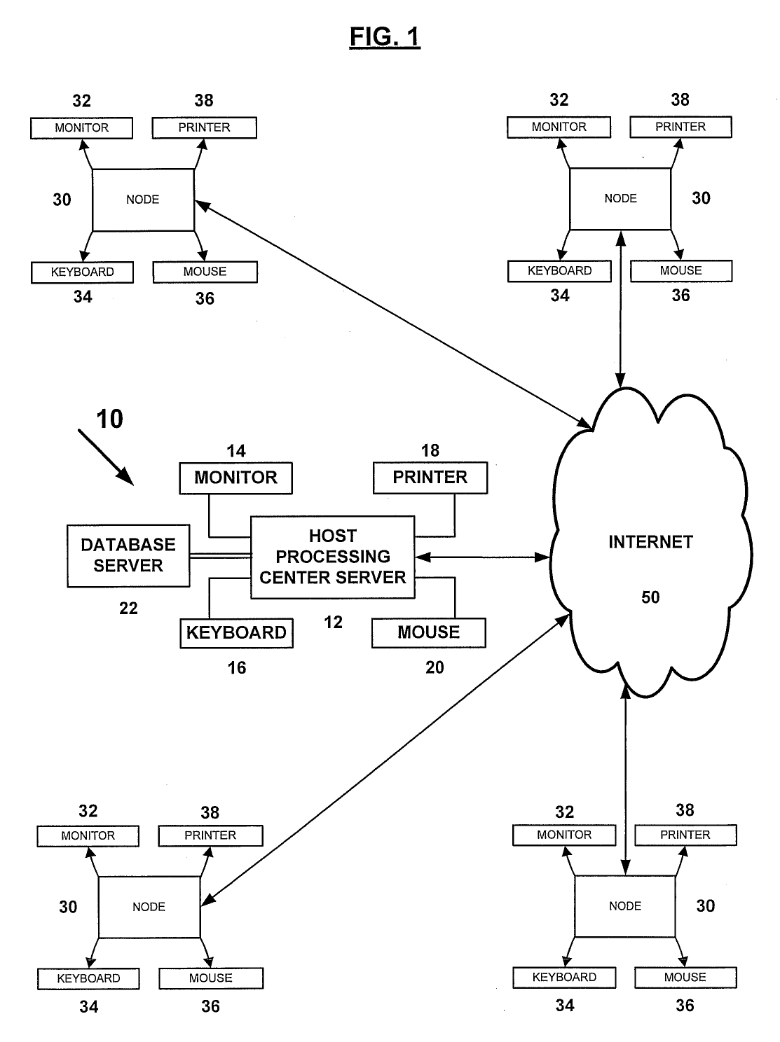

Turning now to FIG. 1, there is shown a high level pictorial schematic of the overall system of the subject invention which is designated system 10. The host data processing center 10 has a central processing unit 12 interoperatively linked to: a monitor 14; a keyboard 16; a printer 18; and, a mouse 20. It is understood that the listed peripherals could be removed and/or additional peripheral devices could be included with the host data processing center 10 as system or local needs require.

The host data processing center 10 is linked via conventional means to internet cloud 50, and subsequently to one or more remote nodes. It is contemplated that a remote node could be co-located with the host data processing center 10 if local needs require. The internet 50 linkage can be through wireless or hardwire needs or a combination of both as network needs dictate. The linked data processing center and nodes can be part of a local area network (LAN), a wide area network (WAN), or as part of an internet or intranet network. Each of the nodes will generally have a CPU 30 linked to: a monitor 32; a keyboard 34; a printer 38; and, a mouse 36. It is understood that the listed peripherals could be removed and/or additional peripheral devices could be included with the remote node as system or local needs require.

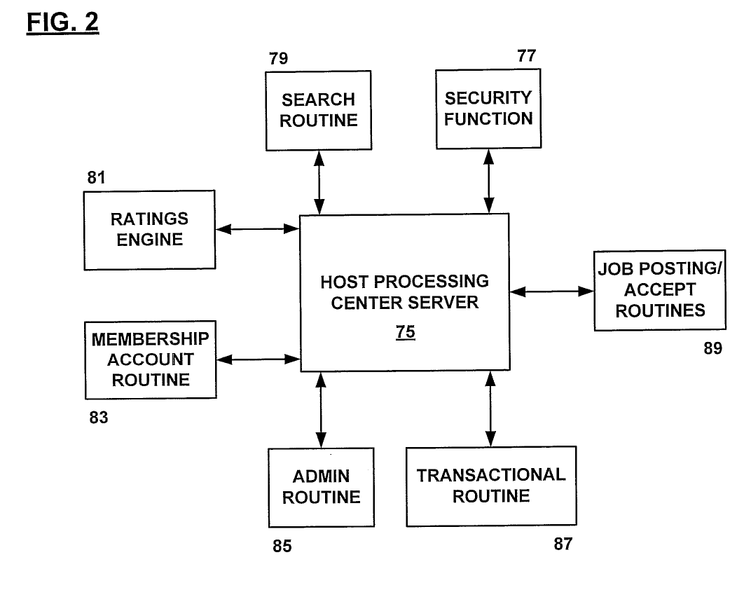

The remote nodes will serve as the entry point by a system user who is posting a commodity to be potentially acquired by a third party. A potential transaction agent will also access the system through a remote node and the various routines and functionality, as described in FIG. 2, will match the wants and needs to facilitate a potential transaction.

Turning next to FIG. 2, there is shown a block diagram of certain routines and functionality hosted by the host data processing center 10 and its central processing unit 12 and now identified as the host processing center and server 75.

The host processing center and server 75 has a security function 77 wherein a system user can log-in. after successful log-in, the user, depending upon their administrative level, can perform system set-ups, change and maintain password data, set-up report formats, or establish timing parameters for system sweeps. The search routine 79 allows system users to scroll through listings of commodities that have been posted to the system by commodities agents; or, in the alternative, commodities agents can search for potential matches by scrolling through lists of needs posted by third parties or by transaction agents. In a sense, reversing the roles of commodities agent and transaction agent. It is important to note, that the transaction agent and the third party can be the same party. This is achieved when an entity requiring a particular commodity or service becomes a system user through membership or other participation, and takes on the role of transaction agent for their own benefit

Searching through the system can be facilitated by selection of search criteria that can include: commodity categories such as: resume search by job function; services search by industry description; or, product search by SSIC coding.

The system also comprises a ratings engine 81 for the purpose of establishing reliability or credit ratings, transactional data, or calculated bounty payments. There is a membership routine 83 which allows for the acquisition, processing and storage of account data for each category of system user. This data can be used to facilitate generation of a transaction contract that, when fully executed, will result in a posted bounty having been earned by a transaction agent. Further, there is an administrative routine 85 that can process the inter-relationships with the other routines, direct data for storage or manipulation, and interface with the ratings engine as required. Transactional routine 87 allows for the processing of bounty data and payments. Job posting and acceptance routines 89 allow system users to post the descriptions of the commodities that they represent, or to post acceptances of listed offers preparatory to a contract being generated.

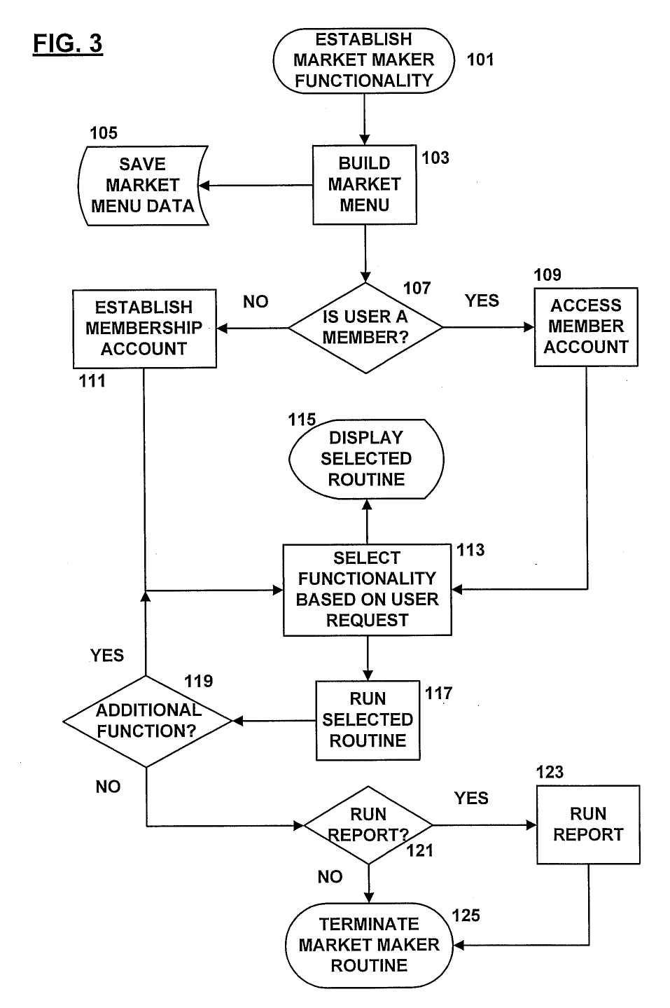

FIG. 3 is an upper level flowchart of the method of the present invention. The method is being viewed from the system perspective as opposed to that of the system user.

The method flow begins at step 101 where the market functionality of the system has been activated. From step 101, the system flow advances to step 103 where a menu of the various routines and available functionality is assembled based upon a system architect based upon the modules selected for embedding within the system. It is contemplated that the system can be custom assembled as individual functional modules become available. The menu, when assembled, is stored to a database at step 105.

Returning to step 103, after saving the market menu, the system flow advances to the query at step 107 which asks if the system user is a member. If the response to the query is “YES” then the flow advances to step 109 where the system accesses the user's membership account before continuing on to step 113 where the system functionality, based on the membership status, of the user is made accessible to the user. The routine selected by the system user will then be displayed at step 115. Returning to the query at step 107, if the response to the query is “NO”, then the system flow advances to step 111 where the system user can establish a membership account. From step 11, the flow will advance to step 113 where the system functionality, based on the membership status of the user, is made accessible to the user. The routine selected by the system user will then be displayed at step 115. From step 113, the system flow advances to step 117 where the selected routine is run before advancing to the query at step 119.

At step 119, the system queries as to whether an additional function or routine is required by the system user. If the response to the query is “YES”, then the system returns to re-enter the system flow in front of step 113. However, if the response to the query at step 119 is “NO”, then system flow advances to the query at step 121 which asks if the system user wants the system to generate a report in respect of the transaction just completed. If the response is “YES”, then the system will prompt the user to select a format for the report from the system's forms library and then the system will generate an appropriate report at step 123 before advancing to step 125 where the market maker routine will be ended. If the response to the query at step 121, however, is “NO”, then the flow will advance directly to step 125 where the market maker routine will be ended.

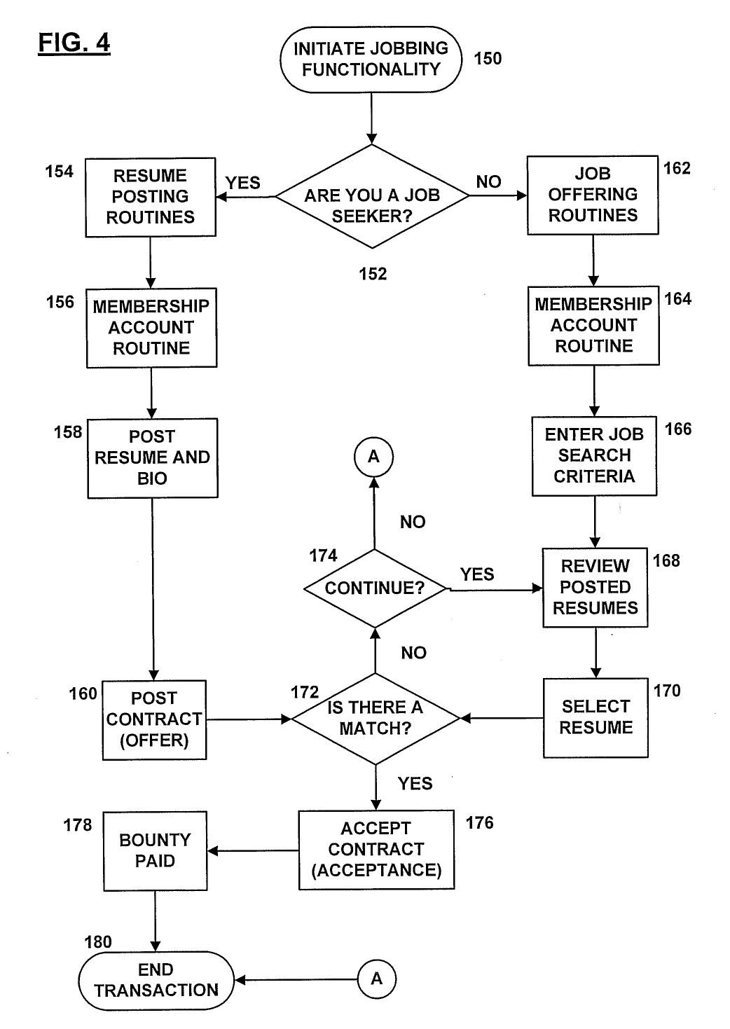

FIG. 4 is a flowchart of the method for the job maker routine of the present invention. There are a number of alternative routines contemplated by the present invention. FIG. 4 illustrates a sequence of steps in a jobbing routine where the commodity to be made available is a person in search of a job.

The jobbing routine is initiated at step 150 where the system user, either in search of a job, or in search of a bounty for placing a prospective job holder, enters the system flow. From step 150, the system flow advances to a query at step 152 which asks if the system user is a job seeker. If the response to the query is “YES”, then the flow advances to step 154 which places the user on resume posting track prior to entering membership account information at step 156. At this step, the user will be prompted to enter account identification; or, if the user does not have an account, then the user will be prompted to establish one. From step 156, the system flow advances to step 158 where the user is prompted through a number of system screens that allow the user to post a resume. The functionality can also allow entry of data into a system specified format to create a user bio. From step 158, the flow advances to step 160 where the parameters of the transaction contract are established. These parameters will include legal notices, the posting of the bounty for a successful match, and the additional terms of employment that the user might be looking for. From a contract point of view, this step constitutes the contract “offer”.

The posting of the bounty can be accomplished in several ways depending upon the needs of the user. The user can escrow the bounty by charging the amount against a credit card or by applying any system stored credit. In an alternative, the user can simply post the intended bounty and wait until a match is verified and a transaction completed before paying the bounty to a transaction agent. The transaction agent is a system user who has identified a posted resume and found a potential employer who is ready, willing and able to hire the commodity agent (that is, the system user who has posted the bounty).

From step 160, the system flow advances to a query at step 172 which asks if a match between a posted resume and an employer need has been identified. If the response is “YES”, then the system advances to step 176 where the contract is agreed to by the transaction agent. From a contract point of view, this step constitutes the contract “acceptance”. When the contract has been offered and accepted, and the transaction has been fulfilled, the bounty offered by the commodity agent will be paid to the transaction agent at step 178. From step 178, the flow advances to step 180 where the transaction is terminated.

Returning to the query at step 172, if the response to the query is “NO”, then the flow advances to the query at step 174 which asks if the user wants to continue. If the response is “NO”, then the flow advances along path A to re-enter the system flow at step 180 where the jobbing functionality is terminated. However, if the response to the query at step 174 is “YES”, then the flow advances to step 168 to continue resume and bio review.

Returning then to the query at step 152, if the response to the query is “NO”, then the system assumes that the user is interested in tracking resumes instead of posting them. The system flow then advances to the job offering track at step 162. From step 162, the system flows to step 164. At this step, the user will be prompted to enter account identification; or, if the user does not have an account, then the user will be prompted to establish one. The flow then advances to step 166, where job search criteria can be entered. As previously discussed, the job search can be established with a simple listing prompt in which all posted resumes are listed, or the user can establish specific search parameters. The user will review the selected batch of posted resumes at step 168 and select a resume at step 170 for review. When a resume is selected, or if a null entry is indicated, the system flow advances to the query at step 172 which asks if a match between a posted resume and an employer need has been identified. The flow continues from step 172 as previously identified.

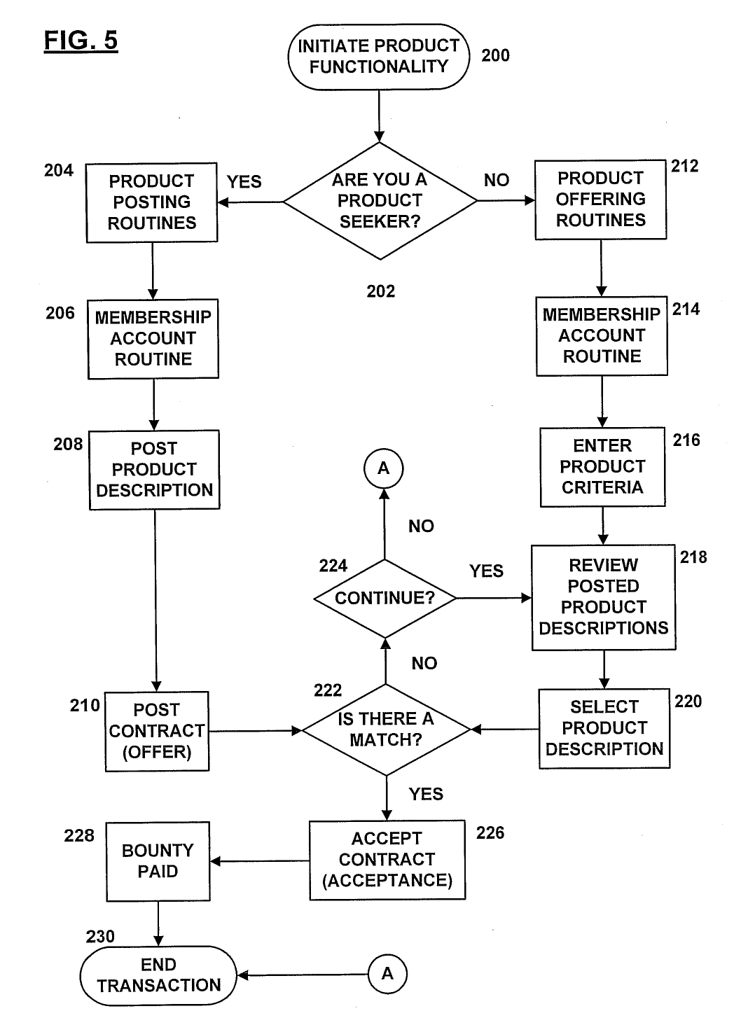

In an alternative routine to that contemplated by FIG. 4, FIG. 5 is a flowchart of the method for the product sale maker routine of the present invention. The product routine is initiated at step 200 where the system user, either in search of a product or service, or in search of a bounty for placing a prospective seller with a buyer, enters the system flow. From step 200, the system flow advances to a query at step 202 which asks if the system user is a product seeker. If the response to the query is “YES”, then the flow advances to step 204 which places the user on a product posting track prior to entering membership account information at step 206. At this step, the user will be prompted to enter account identification; or, if the user does not have an account, then the user will be prompted to establish one. From step 206, the system flow advances to step 208 where the user is prompted through a number of system screens that allow the user to post a description of the product or service being sought. The functionality can also allow entry of data into a system specified format to create a user needs description. From step 208, the flow advances to step 210 where the parameters of the transaction contract are established. These parameters will include legal notices, the posting of the bounty for a successful match, and the additional terms of sale or product description that the user might be looking for. From a contract point of view, this step constitutes the contract “offer”.

Here, too, the posting of the bounty can be accomplished in several ways depending upon the needs of the user. The user can escrow the bounty by charging the amount against a credit card or by applying any system stored credit. In an alternative, the user can simply post the intended bounty and wait until a match is verified and a transaction completed before paying the bounty to a transaction agent. The transaction agent is a system user who has identified a posted product need and found a potential supplier who is ready, willing and able to deliver to the commodity agent (that is, the system user who has posted the bounty).

From step 210, the system flow advances to a query at step 222 which asks if a match between a posted product or service need and a potential supplier need has been identified. If the response is “YES”, then the system advances to step 226 where the contract is agreed to by the transaction agent. From a contract point of view, this step constitutes the contract “acceptance”. When the contract has been offered and accepted, and the transaction has been fulfilled, the bounty offered by the commodity agent will be paid to the transaction agent at step 228. From step 228, the flow advances to step 230 where the transaction is terminated.

Returning to the query at step 222, if the response to the query is “NO”, then the flow advances to the query at step 224 which asks if the user wants to continue. If the response is “NO”, then the flow advances along path A to re-enter the system flow at step 230 where the product or service functionality is terminated. However, if the response to the query at step 224 is “YES”, then the flow advances to step 218 to continue resume and bio review.

Returning then to the query at step 202, if the response to the query is “NO”, then the system assumes that the user is interested in looking to review product needs instead of posting them. The system flow then advances to the job offering track at step 212. From step 212, the system flows to step 214. At this step, the user will be prompted to enter account identification; or, if the user does not have an account, then the user will be prompted to establish one. The flow then advances to step 216, where product search criteria can be entered. As previously discussed, the product search can be established with a simple listing prompt in which all posted product needs are listed, or the user can establish specific search parameters. The user will review the selected batch of posted product needs at step 218 and select a product or service need at step 220 for review. When a product or service need is selected, or if a null entry is indicated, the system flow advances to the query at step 222 which asks if a match between a posted product need and a potential supplier has been identified. The flow continues from step 222 as previously identified.

In the claims, means or step-plus-function clauses, are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of making a market within a host data processing system, said method comprising the steps of:
(a) establishing a data base, said data base further comprising data relative to a commodity that is available, said data posted by a commodity agent;
(b) determining a bounty to be paid to a transaction agent, by said commodity agent, for a successful acquisition of said commodity by a third party;
(c) posting a description of said commodity, together with a listing of said bounty, on said data processing system for review by a remote node through an internet connection in cooperation with said data processing system;
(d) running a matching routine for said posted description with one or more needs descriptions posted by a potential transaction agent of said commodity; and
(i) if a match is determined between said one or more needs descriptions and said described commodity then creating a contract in respect of said match; or
(ii) if no match is determined between said one or more needs descriptions and said described commodity, then maintaining said posted description in said data base for use in a future running of said matching routine; and
(e) causing said bounty to be payable by said commodity agent to said transaction agent in respect of said contract to complete a transaction.

2. The method of claim 1 wherein said commodity is an individual seeking a job.

3. The method of claim 1, wherein said commodity is a service.

4. The method of claim 1, wherein said commodity is a good.

5. The method of claim 2, wherein said data base further comprises a resume of said individual seeking a job, and wherein said resume is capable of being downloaded from said host data processing system by a third party via a link from said remote node to said internet.

6. The method of claim 4, wherein said data base further comprises a description of said service, and wherein said description is capable of being downloaded from said host data processing system by a third party via a link from said remote node to said internet.

7. The method of claim 5, wherein said data base further comprises a description of said good, and wherein said description is capable of being downloaded from said host data processing system by a third party via a link from said remote node to said internet.

8. The method of claim 1, wherein said running of a matching routine step is performed at pre-selected intervals.

9. The method of claim 1, wherein said running of a matching routine step is performed continuously.

10. The method of claim 1, wherein said running of a matching routine step is performed on an as-needed basis.

11. The method of claim 1, further comprising the step of: generating a report in respect of said transaction.

12. A system for making a market within a host data processing system, said system comprising:
(a) a data base, said data base further comprising:
(i) data posted by a commodity agent relative to a commodity that is available, said data further comprising a bounty to be paid to a transaction agent for a successful acquisition of said commodity by a third party;
(ii) a posted description of said commodity, together with a listing of said bounty, for review by a remote node through an internet connection in cooperation with said data processing system;
(b) a matching routine for matching said posted description with one or more needs descriptions posted by a potential transaction agent; and
(i) if a match is determined between said one or more needs descriptions and said described commodity then creating a contract in respect of said match, causing said bounty to be payable by said commodity agent to said transaction agent in respect of said contract to complete a transaction; and
(ii) if no match is determined between said one or more needs descriptions and said described commodity, then maintaining said posted description in said data base for use in a future running of said matching routine.

13. The system of claim 12, wherein said system further comprises printing means for printing a report in respect of said transaction.

14. The system of claim 12, wherein said system further comprises a forms library for generating standardized reports in respect of said transaction.

15. The system of claim 12, wherein said system further comprises selection means for selecting between entry of commodity data to said data base or entry of review criteria for reviewing said commodity data.

16. The system of claim 12, further comprising payment acceptance means for allowing a user of said system to make a payment in respect of a use of said system.

17. The system of claim 16, wherein said payment acceptance means is capable of taking said payment from said user of said system for said bounty on an escrow basis, said escrowed payment to be released to said transaction agent upon a completed transaction.

18. The system of claim 12, wherein said commodity is selected from a group comprising:
(a) an individual seeking a job;
(b) a service; and
(c) a good.

19. A system enabling operation of a web-based incentive commodity acquisition routine, said routine involving an originator designating a desired commodity, interacting with a central host controller or manager system, said system comprising:
(a) a host manager system means for enabling communication and interaction with an originator seeking module means seeking said designated desired commodity, said host manager system means further comprising:
(i) an operable database of one or more participants;
(ii) a query generator management module for managing originating queries from an originator and from one or more participants other than said originator;
(iii) a communication controller module for enhancing communication between defined modules and said one or more participants in said system; and
(iv) a facilitator controller module for facilitating enhanced and secure communication between said defined modules and at least one of said one or more participants; and
(b) a plurality of electronic communication pathways between said host manager system means and said originator seeking module enabling a transfer of at least one desired commodity designation.

20. The system of claim 19, said system further comprising a posted incentive bounty, said bounty posted by a participant in respect of an acquisition of said commodity.
